(19) United States
(12) Patent Application Publication
(10) Pub. No.: US 2023/0071409 A1
(43) Pub. Date: Mar. 9, 2023

(54) EXPANDED DRY PRODUCT FOR IMPROVING THE DENTAL HYGIENE OF A PET

(71) Applicant: MARS, INCORPORATED, McLean, VA (US)

(72) Inventors: Laura TRASSY, Aimargues (FR); Karine BRECIN, Aimargues (FR)

(73) Assignee: MARS, INCORPORATED, McLean, VA (US)

(21) Appl. No.: 17/797,858

(22) PCT Filed: Feb. 10, 2021
(86) PCT No.: PCT/US2021/070137

§ 371 Date: Aug. 5, 2022

(30) Foreign Application Priority Data
Feb. 10, 2020 (EP) 20305127.1

(51) Int. Cl. A23K 20/147; A23K 50/42; A23K 20/158; A23K 20/163; A23K 10/30; A23K 10/20

(52) U.S. Cl. CPC A23K 20/147; A23K 50/42; A23K 20/158; A23K 20/163; A23K 10/30; A23K 10/20

(57) ABSTRACT

The present disclosure relates to a low-density dry food composition having a penetration rate of at least about 30% and comprising at least, by weight relative to the total weight of said composition: a. a protein source in an amount ranging from about 15% to about 30%, b. fat in an amount ranging from about 5% to about 15%, c. starch in an amount ranging from about 35% to about 5% and d. a total dietary fibers source in an amount ranging from about 3% to about 12%. The disclosure also relates to methods of use for improving oral hygiene, and methods for manufacturing said disclosure.

### CROSS-REFERENCE TO RELATED APPLICATIONS

This application is a U.S. National Stage Patent Application under 35 U.S.C. § 371 of International Patent Application No. PCT/US2021/070137, filed on Feb. 10, 2021, which claims priority to European Patent Application No. 20305127.1, filed on Feb. 10, 2020, the contents of each of which is are incorporated herein by reference in its entirety in their entireties, and to each of which priority is claimed.

The present disclosure generally relates to dental hygiene. More specifically, the present disclosure relates to food compositions for improving the dental hygiene of animals, e.g., companion animals.

More and more studies in the last decades have brought to light the importance of oral health, and in particular of dental health, in the life of domestic animals, in particular in dogs and cats.

Many domestic animals suffer from dental health problems. The main factor in the development of these problems is the formation of plaque on the surface of the teeth. They contain bacteria and other components that adhere to the surface of the teeth. These elements accumulate both above and below the gum line which leads to inflammation, or gingivitis, and malodors in the dental cavity. The formation of tartar, or calculus, also contributes to these problems. Dental calculus forms on the tooth surface around the gum line and can serve as a starting point for additional accumulation of plaque. As a consequence, the lack of oral hygiene causes plaque deposition and calculus formation, which harbors the bacteria and eventually induces gingival inflammation.

Accordingly, there is an increasing demand from pet owners for treats and food products useful in improving the health condition of their pets' mouth, and in particular in preventing the onset of dental and/or gum issues. Management of mouth health of our pets has consequently become an increasing part of the veterinary everyday work and an ever-growing priority for pets' food manufacturers.

Wild animals are less susceptible than pets to the formation of plaque and calculus due to the foods they eat which mechanically eliminate plaque and calculus from the teeth. The commercial food consumed by pets, however, while usually much better from a nutritional point of view, are not able to subject the teeth of the pets to sufficient abrasive forces to clean the teeth. Even dried kibbles are able to abrade the teeth only to a very limited extent, both in terms of brush efficiency and in terms of teeth' s surface effectively in contact with the kibble, most often because dried kibbles usually crumble when chewed by the pet.

Various strategies are available to pet owners for improving their pet's dental health, such as the use of a toothbrush, of dental sprays, or of tooth wipes. However, using these tools can be very unpleasant, both for the pet and for his owner. Giving them raw bones, hooves or even antlers to partially reproduce the way wild animals clean their teeth is not accessible to everyone and can even be advised against by veterinarians as they can cause oral puncture injuries, or even broken teeth. The same risks exist with giving a dog ice cubes.

Chew toys and bully sticks are also available on the market as ways to help maintain a good oral health for your pets. Their efficiency is however limited, and their cost, which comes in addition to their food, can become quite high in the long, or even short, term.

Finally, as mentioned above, kibbles and treats having dental health improved properties are available. While these products indeed have a positive impact on our pet dental health, their efficiency is however limited. Kibbles in particular, and more particularly dry kibbles, are too friable and accordingly crumble when chewed. They moreover come into contact with only a small part of the teeth, and as such only act on this part, leaving the rest of the teeth untreated.

Therefore, there is a need to provide kibbles, and in particular dry kibbles, having an improved mouth health/hygiene efficiency, and in particular an improved dental health efficiency.

There is a need to provide kibbles, and in particular dry kibbles, having an improved dental plaque reduction effect.

There is a need to provide kibbles, and in particular dry kibbles, having an improved gingivitis reduction effect.

There is a need to provide kibbles, and in particular dry kibbles, having an improved tartar reduction effect.

There is a need to provide kibbles, and in particular dry kibbles, having an improved halitosis reduction effect.

There is a need to provide kibbles, and in particular dry kibbles, having an increased contact with the teeth of the pet consuming it.

There is a need to provide kibbles, and in particular dry kibbles, presenting an improved dental health efficiency while not being fragile.

There is a need to provide kibbles, and in particular dry kibbles, presenting an improved dental health efficiency while not being too friable.

The present disclosure aims at satisfying all or part of these needs.

The purpose and advantages of the disclosed subject matter will be set forth in and are apparent from the description that follows, as well as will be learned by practice of the disclosed subject matter. Additional advantages of the disclosed subject matter will be realized and attained by the embodiments particularly pointed out in the written description and claims hereof.

According to a first aspect, the present disclosure relates to a low-density dry food composition including at least:
a. a protein source in an amount ranging from about 15% to about 30% by weight relative to the total weight of the composition,
b. fat in an amount ranging from about 5% to about 15% by weight relative to the total weight of the composition,
c. starch in an amount ranging from about 35% to about 65% by weight relative to the total weight of the composition; and
d. total dietary fibers in an amount ranging from about 3% to about 12% by relative to the total weight of the composition, said composition having a penetration rate of at least about 30%.

In some embodiments, a composition of the disclosure can have a penetration rate of from about 30% to about 75%, in particular from about 35% to about 65%, and more particularly from about 35% to about 60%.

In other embodiments, the composition of the disclosure can include a protein source in an amount ranging from about 18% to about 25% by weight relative to the total weight of the composition.

In other embodiments, the protein source of a composition of the disclosure can be selected from vegetal and animal proteins, and in particular:
the said vegetal protein source can be selected from soybean, chickpea, pea, corn gluten, lentils and barley vegetal proteins, and are more particularly corn gluten vegetal proteins; and
the said animal protein source can be selected from poultry, beef, chicken, chicken meal, lamb, lamb meal, dried egg, fish, fish meal, meat and bone meal, meat byproducts, insects, and meat meal animal proteins, and are more particularly poultry animal proteins.

In particular, the protein source of a composition of the disclosure can be corn gluten vegetal proteins and poultry animal proteins.

In an embodiment, the ratio of animal protein to vegetal protein in a composition of the disclosure can be from 1/2 to 2/1 and is in particular of 2/1.

In an embodiment of the disclosure, the composition can include fat in an amount ranging from about 5% to about 15% by weight, more particularly from about 5% to about 12% by weight, and in particular in an amount of about 8% to about 12% by weight relative to the total weight of the composition.

In particular, the fat source of a composition of the disclosure can be selected from pork fat, pork lard, poultry fat, chicken fat, beef fat, lamb fat, fish oil and sunflower, and is in particular pork fat.

In an embodiment of the disclosure, the composition can include starch in an amount ranging from about 35% to about 65% by weight, in particular from about 37% to about 55% by weight, relative to the total weight of the composition.

In particular, the starch source within the composition of the disclosure can be selected from wheat, barley, tapioca, wheat flour, corn flour, rice, potatoes, peas and oat starch, and are in particular selected from wheat, wheat flour and corn flour starch.

In an embodiment of the disclosure, the composition can include total dietary fibers in an amount ranging from about 4% to about 10% by weight, in particular from about 5% to about 8% by weight relative to the total weight of the composition.

In particular, the fibers source in a composition of the disclosure can be selected from beet pulp, soybean hulls, bran from wheat, cellulose, chicory, corn, rice bran, whole grain oat and whole grain barley fibers, and are more particularly chicory fibers.

In an embodiment of the disclosure, the composition can include ash in an amount ranging from about 2% to about 10% by weight, in particular from about 3% to about 9% by weight, and more particularly from about 5% to about 6.5% by weight, relative to the total weight of the composition.

A composition of the disclosure can in particular have a volume density ranging from about 100 g/L to about 250g/L.

In an embodiment of the disclosure, the composition can include an amount of water ranging from about 2% to about 11% by weight, in particular from about 5% to about 11% by weight, and in particular from about 8% to about 11% by weight, relative to the total weight of the composition.

In an embodiment of the disclosure, the composition can also include other mechanical or also chemical or biological active principles for increasing Tartar reduction, dental plaque reduction, gingivitis reduction and/or halitosis reduction. Such active principles can be, without limitation, polyphosphate or polyphosphate derivatives.

In a particular embodiment, a composition of the disclosure does not include pregelatinized starch.

In a particular embodiment, a composition of the disclosure does not include glycerol.

A composition of the disclosure can in particular have a substantially cobbled or paved shape having a rectangular base of width between about 5 mm and about 14 mm and length between about 8 mm and about 20 mm, and in particular a substantially cobbled shape having a rectangular base of width between about 5 mm and about 14 mm and length between about 8 mm and about 20 mm.

A composition of the disclosure can in particular have a thickness between about 7 mm and about 30 mm, in particular between about 8 mm and about 25 mm, and more particularly between about 10 mm and about 20 mm.

As previously mentioned, a composition of the disclosure is in particular a kibble.

According to another aspect, the present disclosure also relates to a low-density dry food composition for its use in the improvement and/or the maintenance of mouth health. More particularly, the disclosure relates to a low-density dry food composition for its use in the improvement and/or maintenance of dental health.

In still yet another aspect, a composition of the disclosure can be for use in the prevention and/or treatment of a disorder selected from dental plaque, gingivitis, tartar and halitosis.

In some embodiments, the low-density dry food composition of the disclosure and its implementation according to the disclosure, is for an animal, in particular a non-human mammal, more particularly a pet, and in particular a cat or a dog.

### DETAILED DESCRIPTION

Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them. The following definitions are provided for the present specification, including the claims.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

As used herein, the term “effective amount”, may be understood as an amount of an ingredient, nutrient or agent that is sufficient to have a beneficial impact on dental plaque reduction, gingivitis reduction, tartar reduction and/or halitosis reduction. In the context of the disclosure, as an example, it means an amount of immunoglobulins that is sufficient for reducing or eliminating oral health compromising (“OHC”) microorganisms.

The terms “prevent” or “prevention” in the present disclosure refers to a reduction in the degree of the risk or of the probability of occurrence of a given phenomenon, that is to say, in the present disclosure, of a disorder as previously defined, e.g., dental plaque, gingivitis, tartar and halitosis.

The terms “treat” or “treatment” or “therapy” in the present text refers to the administration or consumption of a composition according to the disclosure with the purpose to cure, heal, alleviate, relieve, alter, remedy, ameliorate, improve, or affect a disorder according to the disclosure, the symptoms of the condition, or to prevent or delay the onset of the symptoms, complications, or otherwise arrest or inhibit further development of the disorder in a statistically significant manner.

As used herein, the terms “animal” or “pet” mean a domestic animal including, but not limited to domestic dogs, cats, horses, cows, ferrets, rabbits, pigs, rats, mice, gerbils, hamsters, horses, and the like. Domestic dogs and cats are particular examples of pets.

As used herein, the terms “animal feed”, “animal feed compositions”, “animal feed kibble”, “pet food”, or “pet food composition” all mean a composition intended for ingestion by a pet. Pet foods may include, without limitation, nutritionally balanced compositions suitable for daily feed, such as kibbles, as well as supplements and/or treats, which may or may not be nutritionally balanced.

As used herein, the term “nutritionally balanced” means that the composition, such as pet food, has known required nutrients to sustain life in proper amounts and proportion based on recommendations of recognized authorities, including governmental agencies, such as, but not limited to, Unites States Food and Drug Administration's Center for Veterinarian Medicine, the American Feed Control Officials Incorporated, in the field of pet nutrition, except for the additional need for water.

By “expanded product” in the sense of the present disclosure, this means an alveolate product, of which the air cells filled with air represent at least about 50% of the volume of the product, if necessary at least about 65% of the volume, or at least about 80% of the volume, and even up to about 85% of the volume. This expanded structure gives the product according to the disclosure a crunchy character which the consumer likes, which can be quantified, if needed, in particular by measuring the breaking force (expressed in N).

As used herein, the term “penetration rate”, “penetration ratio” or “rate of penetration” corresponds to the ratio between the distance of penetration of teeth in a food product (in millimeters, mm) and the thickness of the corresponding food product (also in millimeters, mm). As it will be described in more details in the following description, the penetration rate is a measured dimension known by the person skilled in the art. It is obtained in penetration tests, measuring the ratio of the distance the probe has penetrated inside a product before its breakage, in mm, compared to the total thickness of the sample, in mm. It is expressed as a percentage (%). For dental application, this penetration rate will mimic the depth a tooth will penetrate a product, compared to the total thickness of the product, before it breaks. The objective is to maximize the penetration rate in order to have a greater “brushing effect” along the tooth surface.

As used herein, the term “coating” means a partial or complete covering, typically on a core, that covers at least a portion of a surface, for example a surface of a core. In one example, a core may be partially covered with a coating such that only part of the core is covered, and part of the core is not covered and is thus exposed. In another example, the core may be completely covered with a coating such that the entire core is covered and thus not exposed. Therefore, a coating may cover from a negligible amount up to the entire surface. A coating can also be coated onto other coatings such that a layering of coatings can be present. For example, a core can be completed coated with coating A, and coating A can be completely coated with coating B, such that coating A and coating B each form a layer.

As used herein, the term “core”, or “core matrix”, means the particulate pellet of a kibble and is typically formed from a core matrix of ingredients and has a moisture, or water, content of less than about 12% by weight. The particulate pellet may be coated to form a coating on a core, which may be a coated kibble. The core may be without a coating or may be with a partial coating. In an embodiment without a coating, the particulate pellet may comprise the entire kibble. Cores can comprise proteinaceous material, fibers materials, starches, and mixtures and combinations thereof. In one embodiment, the core can comprise a core matrix of protein, fibers, and starches.

As used herein, the term “kibble” includes a particulate pellet like component of animal feeds, such as dog and cat feeds, typically having a moisture, or water, content of less than about 20% by weight, relative to the total weight of the kibble. Kibbles may range in texture from hard to soft. Kibbles may range in internal structure from expanded to dense. Kibbles may be formed by an extrusion process. For instance, a kibble can be formed from a core and a coating to form a kibble that is coated, also called a coated kibble. It should be understood that when the term “kibble” is used, it can refer to an uncoated kibble or a coated kibble.

As used herein, the term “extrude” means an animal feed that has been processed by, such as by being sent through, an extruder. In one embodiment of extrusion, kibbles are formed by an extrusion processes wherein raw materials, including starch, can be extruded under heat and pressure to form the pelletized kibble form, which can be a core. Any type of extruder can be used, non-limiting examples of which include single screw extruders and twin-screw extruders.

Within the disclosure, the expression “high-volume aerated” with respect to a composition of the disclosure, such as a kibble, refers to a composition having a porous matrix. Such a composition has a porosity ranging from about 50% to about 85%, preferentially from about 60% to about 75%. The porosity may be measured by X-ray. The porosity is the measure of the void (i.e. “empty”) spaces in the kibble, expressed as a fraction of the volume of voids over the total volume of the kibble (as a percentage).

“Aerated” (or “whipped”) refers to the incorporation of a gas into a food material. For purposes herein, the gas is not particularly limited, and may be, for example, air, nitrogen, carbon dioxide, and gas combinations thereof. The gas can be added or can be the resultant of the manufacturing process. Preferentially, according to the disclosure, the gas consists the air resulting from the “flash evaporation”, meaning the process by which some of a liquid, here water of the dough, instantly boils — or flashes — after it has been heated and sent through a chamber that has reduced pressure. It is the reduction in pressure between the interior of the extruder and atmospheric pressure at the outlet that results in some of the liquid vaporizing. This phenomenon creates numerous small air cavities in the kibble. Aerated means an expanded kibble with numerous air bubbles internally, we measure the internal “aeration” (the texture itself) by measuring the porosity (described above).

The expression “dry food composition” or “dry food” as used herein relates to a food or a composition with about 20% or less than about 20% of moisture content, relative to the total weight of the composition/food, preferably of about 14% or less than about 14% of moisture content, relative to the total weight of the composition. In general, such dry food or dry composition may even contain much less than about 14% of moisture content, relative to the total weight of the composition, such as from about 1 to about 14% of moisture content. The moisture content of a dry food composition of the disclosure may be measured according to any methods known in the art. As example of suitable method, is as follows: The analysis of water content takes place is 3 stages: 1. weighing of the sample to be analyzed, 2. oven desiccation at 103° C.±2° C. during 4 h ±5 min , 3. weighing of the sample after desiccation. Although this definition is not limited to one specific form of presentation, a dry food or dry composition is generally presented in the form of (biscuit-like) kibbles, and/or dry core components. For instance, dry compositions may be manufactured by mixing together ingredients and kneading in order to make consistent dough that can be cooked. The process of creating a dry pet food is usually done by baking and/or extruding. The dough is typically fed into a machine called an expander and/or extruder, which uses pressurized steam or hot water to cook the ingredients. While inside the extruder, the dough is under extreme pressure and high temperatures. The dough is then pushed through a die (specifically sized and shaped hole) and then cut off using a knife. The puffed dough pieces are made into a dry product, such as a kibble, by passing it through a dryer so that moisture is dropped down to a defined target ensuring stability of the food until consumption. The product/kibble can then be sprayed with fats, oils, minerals, vitamins, natural extracts cocktail, flavors and optionally sealed into packages.

According to the present disclosure, the expression “low-density food composition” intends to refer to a composition having a volume density less than or equal to about 250 g/L, more particularly between about 100 g/L and about 250 g/L, and in particular between about 100 g/L and about 220 g/L.

According to the present disclosure, the terms “porous” or “porosity” with respect to a composition of the disclosure, such as a kibble, intends to refer to a measure of the void (i.e. “empty”) spaces in the composition. It is expressed as a fraction of the volume of voids over the total volume, between 0 and 1, or as a percentage between 0% and 100%. The porosity of a composition of the disclosure may be measured according to any methods known in the art. For example, the porosity may be measured by X-ray. The porosity is the measure of the void (i.e. “empty”) spaces in the kibble, expressed as a fraction of the volume of voids over the total volume of the kibble (as a percentage).

Within the disclosure, the term “substantially” as used herein refers to a set of embodiments related to this feature which are largely but not wholly similar to this feature. For instance, “substantially cylindrical form” intends to refer to strict cylinders but also to cylinders which do not have exactly straight parallel sides and/or exactly a circular or oval cross section. Such form can be qualified as grossly cylindrical.

Within the disclosure, the terms “volume density” or “bulk density” are used interchangeably and refer to the degree of compactness of a substance. The density of a food composition of the disclosure may be measured according to any methods known in the art. As an example of suitable method, the volume density may be measured using a 10 liters pot filled by the kibbles and then weighed, it is so expressed in g/L.

Within the disclosure, the term “significantly” used with respect to change intends to mean that the observed change is noticeable and/or it is statistically meaningful.

The list of sources, ingredients, and components as described hereinafter are listed such that combinations and mixtures thereof are also contemplated and within the scope herein.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present disclosure have been illustrated and described, various other changes and modifications can be made without departing from the spirit and scope of the disclosure. As will also be apparent, all combinations of the embodiments and features taught in the foregoing disclosure are possible and can result in preferred executions of the disclosure.

Method for determining the water content/moisture content in a dry food composition of the disclosure

The analysis of the water content of a food composition, in particular of a dry food composition such as a kibble, can be performed on the basis of a simple three-steps method well known by the person skilled in the art.

This method comprises the weighing of the sample to be analysed, followed by the desiccation of said sample in an oven, and finally the weighing of the sample after its desiccation. A sample according to the present disclosure is an individual kibble.

Various ISO standard have been published detailing the requirements, specifications, guidelines or characteristics that can be used for the determination of moisture in animal feeding stuffs (see for example the ISO standard 6496:1999, incorporated herein by reference).

Method for Determining Various Texture Parameters a Dry Food Composition of the Disclosure

Distance and Rate of Penetration

Here is presented a method allowing to determine the Penetration Distance required to break a dry food composition (a kibble) using a probe simulating a pet tooth (for example cat or dog) penetrating into a corresponding dry food sample to its rupture.

More particularly, four steps during the test can be identified:
A) the probe descends at a constant speed of 300 mm/min;
B) once the probe touches the food sample (kibble) surface,
C) the probe penetrates a certain distance into the kibble to break the sample; and
D) the probe returns to its starting height above the sample.

The distance of penetration can thus be measured and corresponds to the penetration distance of the probe into the sample until rupture of the sample.

The distance of penetration can be expressed in millimeters (mm).

In addition, the stiffness is also measured. The stiffness required to break a kibble is defined by ΔF/Ax, where ΔF is the Force variation and Δx is the penetration distance variation. The stiffness is measured after step B) here-above, as it corresponds to the slope of a Force-distance curve when the probe starts to penetrate the food sample. Said stiffness also corresponds to the maximum peak in a derivative of Force-distance of penetration curve computed (abscissa: Distance of penetration (mm) and ordinate: Derivative (N/mm)).

The rate of penetration (or penetration rate) of a dry food composition (kibble) is defined as the ratio between the distance of penetration mentioned above in millimeters (mm) and the thickness of the corresponding food composition—in millimeters (mm)—used to measure the distance of penetration.

Accordingly, the higher the rate of penetration, the higher the pet's tooth's surface effectively in contact with the dry food composition when consumed by the said pet. Which means, in the present case, that the higher the rate of penetration, the higher the effectiveness of the tested dry food composition for cleaning the pet's teeth.

Thickness

The dry food composition (kibble) thickness can be manually measured using, for example, a digital Caliper. Such method is well known by one of ordinary skill in the art.

The thickness can be expressed in millimeters (mm).

Method for Determining the Volume Density of a Dry Food Composition of the Disclosure

The following method can be used to determine the volume density of a dry food composition (kibble) according to the disclosure.

Clean and level a calibrated scale with 1-gram or better resolution. Tare the scale using a clean, dry, calibrated 10-Liter cup (10-L). Position a funnel having a minimum diameter sufficient to allow the kibble to be tested to flow freely, and a maximum diameter at the same point to channel kibble into the 10-L cup or vessel, approximately 2 inches above the top of the 10-L cup with the bottom (outlet) of the funnel blocked. Gently fill the funnel with slightly more than 10-L of kibble to be tested. With the 10-L cup under the funnel, unblock the funnel and allow the kibble to flow into the 10-L cup. Using a straight-edge (such as a ruler or strike stick), remove excess kibble by sliding the straight-edge smoothly across the top of the 10-L cup. The kibble should not be level with the rim of the 10-L cup. Place the 10-L cup on the tared scale and record the results. The volume density is the scale reading (in grams) divided by 10-L. The measurement has to be repeated to calculate an average.

Composition of the Disclosure

In some aspects, the present disclosure relates to a low-density dry food composition.

In some embodiments, a composition according to the disclosure is a low-density dry food composition including at least:
a. a protein source in an amount ranging from about 15% to about 30% by weight relative to the total weight of the composition,
b. fat in an amount ranging from about 5% to about 15% by weight relative to the total weight of the composition,
c. starch in an amount ranging from about 35% to about 65% by weight relative to the total weight of the composition; and
d. total dietary fibers in an amount ranging from about 3% to about 12% by weight relative to the total weight of the composition, said composition having a penetration rate of at least about 30%.

A food composition of the disclosure includes a porous matrix. The porous matrix of a composition provides a high surface area. This is accomplished by way of the low volume density porous matrix comprising a skeletal structure that defines pores that are uniformly or randomly sized and dispersed throughout the porous matrix and its surface as a plurality of intercommunicated pores.

In particular, a dry food composition of the disclosure can have a porosity between about 50% and about 85%.

A dry food composition of the disclosure, for example kibbles, is a high-volume aerated expanded composition thanks to a high level of porosity. A composition of the disclosure is in particular characterized in that it has a penetration rate of at least about 30%.

In some aspects, a composition of the disclosure is characterized by a superior capacity to abrade or brush the teeth of an animal consuming the composition.

In particular, the penetration rate of a composition of the disclosure can be from about 30% to about 75%, in particular from about 35% to about 65%, and more particularly from about 35% to about 60%.

A composition of the disclosure is a low-density composition. According to the disclosure, and as mentioned previously, a composition of the disclosure has a volume density lower than or equal to about 250 g/L. The volume density of a composition of the disclosure may be between about 100 g/L and about 250 g/L, more particularly between about 100 g/L and about 220 g/L, and in particular between about 120 g/L and about 220 g/L.

Such volume density is particularly low, considering that most pet food products on the market have a volume density higher than 250 g/L, and more often higher than 300 g/L or even to 350 g/L.

Various factors influence the volume density of a food composition of the disclosure, such as the ingredients used as well as their ranges of amounts, but also porosity, and shape of the composition.

An expanded food composition of the disclosure may be any three-dimensional shape, e.g., sphere or sphere-like, ellipsoidal (having up to 3 or more diameters), cylinder-like, disk-like, or any other 3-dimensional geometric shape. Preferably, a food composition of the disclosure has a substantially cylindrical form.

Accordingly, a composition of the disclosure in particular has an elongated form and can in particular have a length between about 8 mm and about 20 mm.

In particular, the elongated form of a composition of the disclosure may have an elongated form with a parallelepipedal, such as square, rectangle or lozenge, or a substantially parallelepipedal longitudinal cross-section.

A food composition of the disclosure may be of any three-dimensional shape with any transversal cross-sectional shape, which can for example be chosen among shapes with a circular or oval transversal cross-section or a substantially circular or oval transversal cross-section, shapes with a parallelepipedal, such as square, rectangle or lozenge, or a substantially parallelepipedal transversal cross-section. Transversal cross-sectional shapes of a composition of the disclosure may also present contour displaying shape of object, plant or animals such as flower, heart, bowls, dogs, or cats, or any other possible shapes.

In some embodiments, the low-density dry food composition according to the disclosure, may have a thickness between about 7 mm and about 30 mm, in particular between about 8 mm and about 25 mm, and more particularly between about 10 mm and about 20 mm.

The size of the expanded food composition of the disclosure, and in particular the length and thickness, are such that an individual according to the present disclosure, and in particular a pet, is forced to chew the composition so as to increase contact with the teeth and prevent the individual from swallowing too quickly (reducing then the mechanical effect of friction).

Moreover, as previously mentioned, a low-density composition of the disclosure is dry, i.e. a dried composition. A dry composition of the disclosure may have less than about 15% by weight of water (or moisture) relative to the total weight of the composition, in particular from about 2% to about 12% by weight, more particularly from about 2% to about 11% by weight, in particular from about 5% to about 11% by weight, in particular from about 7% to about 11% by weight, and more particularly from about 8% to about 11% by weight, relative to the total weight of the composition.

In some embodiments, a food composition of the disclosure may be a nutritionally complete food or a functional complement. A complete food is a nutritionally adequate feed for animals, that can be fed as a sole ration and is capable of sustaining life without additional food (aside from water).

A functional complement may include functional ingredients for a dedicated specific effect for the animal. Various functional ingredients may be included. The functional ingredients may include, but are not limited to, a vitamin, a mineral, conjugated linoleic acid, an antioxidant, a microorganism, illustratively a probiotic, a moiety such as a metabolite or a supernatant of culture of such microorganism, an extract from a plant that may contain any of the above, a dietary supplement, or combinations and mixtures of the above. Illustratively, the functional ingredient, or mixture thereof, is selected for its properties in a dental benefit diet.

Proteins

A food composition according to the present disclosure contains one or more distinct source(s) of proteins. Generally, a food composition, and in particular a pet food composition, as described herein includes a plurality of sources of proteins.

As mentioned previously, a composition of the disclosure includes a protein source in an amount ranging from about 15% to about 30% by weight relative to the total weight of the composition.

As used herein, a protein source content ranging from about 15% to about 30% by weight includes a protein content of about 15%, about 16%, about 17%, about 18%, about 19%, about 20%, about 21%, about 22%, about 23%, about 24%, about 25%, about 26%, about 27%, about 28%, about 29% and about 30% by weight relative to the total weight of the composition.

In an embodiment, a composition of the disclosure includes a protein source in an amount ranging from about 18% to about 25% by weight relative to the total weight of the composition.

The proteins present in a composition of the disclosure can be hydrolyzed or non-hydrolyzed.

Proteins present in a composition of the disclosure can be selected from vegetal and animal proteins, i.e. can be of vegetal and/or animal source(s).

In a particular embodiment, a composition of the disclosure includes vegetal proteins and animal proteins.

As vegetal proteins, one may select vegetal proteins from soybean, chickpea, pea, corn gluten, rice, insects, lentils, or barley. Accordingly, the vegetal proteins that can be present in a composition of the disclosure can be selected from soybean, chickpea, pea, corn gluten, insects, lentils and barley vegetal proteins, and mixtures thereof. More particularly, in some embodiments, the vegetal proteins are corn gluten proteins.

As animal proteins, one may select animal proteins from poultry, beef, chicken, chicken meal, lamb, lamb meal, dried egg, fish, fish meal, meat and bone meal, meat byproducts, meat meal, turkey, blood plasma or bone marrow. In particular, the animal proteins can be selected from poultry, beef, chicken, chicken meal, lamb, lamb meal, dried egg, fish, fish meal, meat and bone meal, meat byproducts and meat meal animal proteins.

More particularly, the animal proteins are poultry proteins.

In a particular embodiment, a composition of the disclosure includes corn gluten proteins as vegetal proteins and poultry proteins as animal proteins.

A composition of the disclosure may include animal and vegetal proteins in a ratio animal to vegetal ranging from about 1:4 to about 3:1, in particular from about 1:3 to about 2:1, more particularly from about 2:1 to about 1:2. The animal proteins to vegetal proteins ratio of a composition of the disclosure may in an embodiment be of about 2:1.

According to an embodiment, all or part of the proteins present in a composition of the disclosure may be hydrolyzed proteins. Hydrolyzed proteins may be partially or totally hydrolyzed. Partially hydrolyzed proteins may contain at least 95% of hydrolyzed proteins, preferably at least 98, and more preferably at least 99% of hydrolyzed proteins.

Methods to hydrolyze, partially or totally proteins are well-known.

In some embodiments, the at least partially hydrolyzed proteins have a molecular weight ranging from about 1,000 Da to about 11,000 Da.

As used herein, ranging from about 1,000 Da to about 11,000 Da includes, for example, about 1,250 Da, about 1,500 Da, about 1,750 Da, about 2,000 Da, about 2,250 Da, about 2,500

Da, about 2,750 Da, about 3,000 Da, about 3,250 Da, about 3,500 Da, about 3,750 Da, about 4,000 Da, about 4,250 Da, about 4,500 Da, about 4,750 Da, about 5,000 Da, about 5,250 Da, about 5,500 Da, about 5,750 Da, about 6,000 Da, about 6,250 Da, about 6,500 Da, about 6,750 Da, about 7,000 Da, about 7,250 Da, about 7,500 Da, about 7,750 Da, about 8,000 Da, about 8,250 Da, about 8,500 Da, about 8,750 Da, about 9,000 Da, about 9,250 Da, about 9,500 Da, about 9,750 Da, about 10,000 Da, about 10,250 Da, about 10,500 Da, and about 10,750 Da.

In some embodiments, the at least partially hydrolyzed proteins have a molecular weight ranging from about 2,000 Da to about 5,000 Da.

Fat

In some aspects, a food composition according to the present disclosure contains one or more distinct source(s) of fat.

In some embodiments, a composition of the disclosure includes fat in an amount ranging from about 5% to about 15% by weight relative to the total weight of the composition.

As used herein, from about 5% by weight to about 15% by weight of fat includes, but is not limited to, about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, about 13.5%, about 14%, about 14.5% and about 15% by weight of fat, based on the total weight of dry matter of the composition.

In particular, a composition of the disclosure may include fat in an amount ranging from about 5% to about 12% by weight, and in particular in an amount of about 8% to about 12% by weight relative to the total weight of the composition.

As used herein, the expressions “fat”, “crude fat”, or “source of fat” are intended to refer to any food-acceptable fat and/or oil. The fat in accordance with the present disclosure may be in a fluid form and/or in a solid form. The composition according to the disclosure may include fat from animal origin and/or from vegetal origin. Fat can be supplied by any suitable source known by those skilled in the art.

A suitable vegetal, i.e., plant based, fat source for the purpose of the instant disclosure may include, without limitation, wheat, sunflower, safflower, rapeseed, olive, borage, flaxseed, peanuts, blackcurrant seed, cottonseed, wheat, germ, corn germ as well as oils derived from these and other plant fat sources, and mixtures thereof.

A suitable animal fat source for the purpose of the instant disclosure may include, for example and without limitation, meat; meat by-products such as chicken fat, turkey fat, beef fat, duck fat, pork fat, lamb fat; fish oil, seafood; dairy; eggs, and mixtures thereof.

In a particular embodiment, fat included in a composition of the disclosure may solely be from animal source(s).

In an embodiment, fat in a composition of the disclosure may be selected from pork fat, pork lard, poultry fat, chicken fat, beef fat, lamb fat, fish oil and sunflower, and is in particular pork fat and mixtures thereof.

The fat content of food compositions according to the instant disclosure may be determined by any method known in the art.

Fibers

A food composition according to the present disclosure may contain one or more distinct source(s) of fibers and type of fibers. Generally, a pet food composition as described herein includes a plurality of sources of fibers.

As mentioned previously, a composition of the disclosure includes total dietary fibers in an amount ranging from about 3% to about 12% by weight relative to the total weight of the composition.

As used herein, from about 3% by weight to about 12% by weight of fibers includes, but is not limited to, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 10.5%, about 11%, about 11.5% and about 12% by weight of fibers, based on the total weight of dry matter of the composition.

In particular, a composition of the disclosure may include total dietary fibers in an amount ranging from about 4% to about 10% by weight, in particular from about 5% to about 8% by weight relative to the total weight of the composition.

The total dietary fibers (“TDF”) are the remnants of edible plant cell wall polysaccharides, lignin, and associated substances resistant to hydrolysis by human alimentary tract enzymes. As used herein, the dietary fiber represents the indigestible part of plant foods. The official definition of TDF was published by Trowell H, Southgate D A, Wolever T M, Leeds A R, Gassull M A, Jenkins D J. Letter: Dietary fibre redefined. Lancet. 1976;1(7966):967. doi:10.1016/s0140-6736(76)92750-1.

TDF can be analysed according to the method described by Prosky L, Asp N G, Furda I, DeVries J W, Schweizer T F, Harland B F. Determination of total dietary fiber in foods and food products: collaborative study. J Assoc Off Anal Chem. 1985;68(4):677-679, which is incorporated herein by reference in its entirety.

The most common dietary fibers are lignin, cellulose, hemicellulose, pectin, gums, and resistant starches (also referred to as beta-glucans).

Illustratively, a source of dietary fiber suitable for implementing a composition according to the disclosure includes rice hulls, corn and corn by-products, soybean hulls, beet pulp, dried potato product, cellulose, bran, peanut hulls, pectin and a mixture thereof.

As used herein total dietary fibers include soluble fibers (also referred as fermentable fibers) and insoluble fibers (also referred as non-fermentable fibers). Soluble fibers can be defined as being resistant to digestion and absorption in the small intestine and undergo complete or partial fermentation in the large intestine. Insoluble fibers can be defined as non-starch polysaccharides that are resistant to digestion and absorption in the small intestine, and resistant to fermentation in the large intestine.

In practice, a suitable source of soluble fibers, for the purpose of the instant disclosure, may be selected from beet pulp, guar gum, chicory pulp, chicory root, psyllium, pectin, blueberry, cranberry, squash, apples, oats, beans, citrus, barley, peas, and mixtures thereof.

Illustratively, a suitable source of insoluble fibers, for the purpose of the instant disclosure, may be selected from cellulose, whole wheat products, wheat oat, corn bran, flax seed, grapes, celery, green beans, cauliflower, potato skins, fruit skins, vegetable skins, peanut hulls, soy fiber, and mixtures thereof.

In an embodiment, fibers of a composition of the disclosure may be selected from beet pulp, soybean hulls, bran from wheat, cellulose, chicory, corn, rice bran, whole grain oat and whole grain barley fibers, and mixtures thereof. In some embodiments, the fibers of a composition disclosed herein are particularly chicory fibers.

Within the scope of the instant disclosure, the expression “crude fiber” (“CFIB”) is refers to a type of dietary fiber that remains as residue after food receives a standardized laboratory treatment with dilute acid and alkali. The treatment dissolves all the soluble fiber and some of the insoluble fiber in a food. The residue or crude fiber is primarily composed of cellulose and lignin. CFIB may be analysed according to the method described by Henneberg, Wilhelm and Friedrich Stohmann, Beitrage Zur Begrundung einer Rationellen Futterung Der Wiederkauer, Vol. I, II, Schwetschke U. Sohn, Brunswick, 1860, 1865, incorporated herein by reference).

Carbohydrates or NFE

As used herein, the term Nitrogen Free Extract (NFE) refers to the soluble carbohydrate fraction that is included in a food composition disclosed herein. NFE encompasses soluble polysaccharides, starch, gums, mucilages and pectin, if present in the said food composition.

Thus, NFE does not include the insoluble carbohydrate fraction included in the crude fiber material that may, in some embodiments, be present in the said food composition.

Typically, the content of a food composition in Nitrogen Free Extract is determined by subtracting the content of each of the other components (protein, fat, crude fiber, ash) from the whole dry matter of the said food composition.

NFE, or carbohydrates, may be supplied under any suitable source(s), as known in the art. A suitable source of NFE may be selected from starch, oat fiber, cellulose, peanut hulls, beet pulp, parboiled rice, corn starch, corn gluten meal, and any combination of those sources. Grains supplying carbohydrate include, but are not limited to, wheat, corn, barley, and rice.

In some embodiments, the NFE content in a composition according to the instant disclosure ranges from about 28% by weight to about 65% by weight, in particular from about 30% by weight to about 60% by weight, more particularly from about 40% by weight to about 58% by weight, and in particular from about 45% by weight to about 56% by weight based on the total weight of dry matter of the composition.

As used herein, from about 28% by weight to about 65% by weight NFE includes, but is not limited to, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64% and about 65% by weight NFE, based on the total weight of dry matter of the composition.

Starch

In some aspects, a composition of the disclosure further includes starch in an amount ranging from about 35% to about 65% by weight relative to the total weight of the composition.

As used herein, from about 35% by weight to about 65% by weight of starch includes, but is not limited to, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64% and about 65% by weight of starch, based on the total weight of dry matter of the composition.

In an embodiment, a composition of the disclosure includes starch in an amount ranging from about 35% to about 65% by weight, more particularly from about 35% to about 60% by weight, and in particular from about 37% to about 55% by weight, relative to the total weight of the composition.

Various types and sources of starch may be used, so long as the desired properties of the expanded food product are exhibited by the formulation used.

Whole grains, broken grains, flours, roots, and tubers can be used as sources for the starch used to manufacture the porous matrix. Examples of suitable starch sources include rice, brewer's rice, corn, barley, oats, wheat, potato, legumes, and/or other biopolymers. Pure or substantially pure starches may be used if desired. These and other sources of starch can be used to form the porous matrix. Selection of starches having known amylose and amylopectin content can be selected using conventional knowledge in the art. By way of example, waxy corn, rice, and sorghum starch are known to include almost about 100% amylopectin. Conversely, many high amylose starches, e.g., high amylose corn starches, include an amylose content of about 75% of more. Amylose and amylopectin proportions can be selected by using a starting material having starch in the selected proportion, by mixing various starches from various starting materials, or by supplementing starch from natural sources with modified starches such as acid-thinned starches, high amylopectin starches, or high amylose starches. Starch may contain other components such as moisture, protein, and fat.

According to one embodiment, starch in a composition of the disclosure may be a natural starch. A natural starch is a non-modified starch. A preferred natural starch may be a non-modified cereal starch.

According to a particular embodiment, starch in a composition of the disclosure can be selected from wheat, barley, tapioca, wheat flour, corn flour, rice, potatoes, peas and oat starch, and are in particular selected from wheat, wheat flour and corn flour starch.

According to embodiments, a composition of the disclosure does not include high amylose starch or pregelatinized starch. A high amylose content starch has an amylose to amylopectin ratio of at least 40:60, and more preferably about 50:50.

According to a particular embodiment, a composition of the disclosure does not include any starch from tapioca.

In an embodiment, a composition of the disclosure does not include high amylose starch, pregelatinized starch and starch from tapioca.

Ash

A composition according to the disclosure may further include ash (or ashes).

The amount of ash that can be present in a composition of the disclosure may be ranging from about 2% to about 10% by weight, in particular from about 3% to about 9% by weight, and more particularly from about 5% to about 6% by weight, relative to the total weight of the composition.

As used herein, from about 2% by weight to about 10% by weight of starch includes about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5% and about 10% by weight of ash, based on the total weight of dry matter of the composition.

Within the scope of the instant disclosure, the ash is intended to refer to minerals, such as calcium, phosphorus, sodium, chloride, potassium and magnesium.

Immunoglobulin (IgY)

The composition further includes compounds having a chemical activity.

Such compounds can be selected from compounds including, for example, silica, abrasive silica, purified cellulose, sunflower hulls, pea hulls, and mixtures thereof.

Such compounds can be selected from any “chemical” compounds known by the person skilled in the art such as, for example, polyphosphate or polyphosphate derivatives and preferably Hexa-metaphosphate or sodium tripolyphosphate, or essential oils such as thymol, eucalyptol, menthol, mythyl salycilate or any PRN compound (Plaque Reduction Nutrient).

Such compounds can be selected from any “biological” or “biochemical” compounds known by the person skilled in the art such as, for example, probiotics, curcuma, omega 3ss, nucleotides, XOS or immunoglobulins, preferably IgY antibodies such as monoclonal or polyclonal immunoglobulins, or any other compounds know by the person skilled in the art to have a beneficial impact on dental plaque reduction, gingivitis reduction, tartar reduction and/or halitosis reduction (Rahman A. K. M. Shofiqur, Veterinary Science Development 2011; volume 1:e8 or Kyosuke Yokoyama, Journal of oral Science 2007; volume 49, N^{o}3, p 201-206, incorporated herein by reference).

IgY (Immunoglobulin of Yolk) is an IgG immunoglobulin, which is used to immunize healthy egg-laying poultry with a variety of pathogens that cause periodontal disease, so that it produces a large number of corresponding immunoglobulins, which are extracted, separated, and purified to obtain specificity. As an illustrative example of the present disclosure, such pathogens can consist of bacteria, such as, without limitation, Porphyromonas gingivalis (P. gingivalis) and/or Porphyromonas gulae (P. gulae). These composite IgYs have specific binding inhibitory effects on a variety of pathogens that cause periodontal disease, and even at very low concentrations, they can also have an effective effect, and only inhibit pathogenic bacteria, but have no effect on oral symbiotic bacteria. It will never produce drug-resistant strains and double infections, and it has no toxic side effects of chemicals.

“The standard protocol for producing antigen specific IgY is known in the art. As a non-limitative example, hens are usually exposed to the targeted antigen through an injection. This triggers a humoral immune response that manifests itself initially by the production of specific IgY in the blood serum of the immunized hen, followed by its export in the yolk of laid eggs. Once the immune response has been induced, the transovarial passage of IgY takes about 6-7 days (Bollen et al., 1997). The composition of the pool of IgY in the yolk is clearly related to that in the hens' circulating blood (Hamal et al., 2006). The role of egg-yolk antibodies is to provide a passive antibody source to offspring against common avian pathogens until full maturation of their own immune system. IgY has a short half-life (−36 h), which is considerably shorter than the half-life of mammalian IgG, and this feature is suggested to help avoid immune recognition (Suartini, 2014). As an immuno-intervention strategy, IgY presents several advantages over mammalian IgG: i) IgY exhibits up to five times higher affinity and reactivity to a specific antigen than IgG when tested in competition assays (Rahman, 2014), ii) IgY does not bind or activate mammalian complement or Fc receptors, does not bind protein A,G, or rheumatoid factor and therefore cannot elicit non-specific inflammatory responses, particularly in the gastrointestinal tract, when administered orally (Rahman, 2014). Furthermore, IgY does not interfere with mammalian IgG in serological tests.” See WO2016/191389.

In an embodiment, the food composition of the disclosure may comprise probiotics, curcuma, omega 3ss, nucleotides, XOS or immunoglobulins, preferably IgY antibodies such as monoclonal or polyclonal immunoglobulins.

In a specific embodiment, the low-density dry food composition according to the disclosure comprises an effective amount of immunoglobulins, preferably IgY antibodies. More preferentially, said IgY being part of an IgY egg powder.

In an embodiment, the composition of the disclosure further includes immunoglobulins in an amount that does not exceed about 1%, preferentially that does not exceed about 0.9%, about 0.8%, about 0.7%, about 0.6% and more preferentially 0.5% by weight relative to the total weight of the composition. According to an embodiment, the composition of the disclosure further includes immunoglobulins in an amount that does not exceed about 0.5%. According to an embodiment, the composition of the disclosure further includes immunoglobulins in an amount that does not exceed about 0.4%. According to an embodiment, the composition of the disclosure further includes immunoglobulins in an amount that does not exceed about 0.3%. According to an embodiment, the composition of the disclosure further includes immunoglobulins in an amount that does not exceed about 0.2%. According to an embodiment, the composition of the disclosure further includes immunoglobulins in an amount that does not exceed about 0.1%.

As non a limitative example, the composition of the disclosure further includes immunoglobulins in an amount ranging from about 0.001% to about 0.1% by weight relative to the total weight of the composition. As used herein, from about 0.001% by weight to about 0.1% by weight of immunoglobulins includes about 0.001%, about 0.002%, about 0.003%, about 0.004%, about 0.005%, about 0.006%, about 0.007%, about 0.008%, about 0.009%, about 0.01%, about 0.011%, about 0.012%, about 0.013%, about 0.014%, about 0.015%, about 0.016%, about 0.017%, about 0.018%, about 0.019%, about 0.02%, about 0.021%, about 0.022%, about 0.023%, about 0.024%, about 0.025%, about 0.026%, about 0.027%, about 0.028%, about 0.029%, about 0.03%, about 0.031%, about 0.032%, about 0.033%, about 0.034%, about 0.035%, about 0.036%, about 0.037%, about 0.038%, about 0.039%, about 0.04%, about 0.041%, about 0.042%, about 0.043%, about 0.044%, about 0.045%, about 0.046%, about 0.047%, about 0.048%, about 0.049%, about 0.05%, about 0.051%, about 0.052%, about 0.053%, about 0.054%, about 0.055%, about 0.056%, about 0.057%, about 0.058%, about 0.059%, about 0.06%, about 0.061%, about 0.062%, about 0.063%, about 0.064%, about 0.065%, about 0.066%, about 0.067%, about 0.068%, about 0.069%, about 0.07%, about 0.071%, about 0.072%, about 0.073%, about 0.074%, about 0.075%, about 0.076%, about 0.077%, about 0.078%, about 0.079%, about 0.08%, about 0.081%, about 0.082%, about 0.083%, about 0.084%, about 0.085%, about 0.086%, about 0.087%, about 0.088%, about 0.089%, about 0.09%, about 0.091%, about 0.092%, about 0.093%, about 0.094%, about 0.095%, about 0.096%, about 0.097%, about 0.098%, about 0.099% and about 0.1% by weight of immunoglobulins, based on the total weight of dry matter of the composition.

In a preferred embodiment, the immunoglobulin is IgY.

In an embodiment, the composition of the disclosure includes an IgY containing egg powder in a range between 0.01% to 1% by weight relative to the total weight of the composition, depending of the concentration in IgY of said egg powder.

Other Ingredients

A composition according to the instant disclosure may further include one or more trace element(s), in particular a trace element selected from iron, copper, manganese, zinc, iodine and selenium.

The composition according to the instant disclosure may further include one or more vitamin(s), in particular a vitamin selected from vitamin A, vitamin D, vitamin E, ascorbic acid, vitamin K, thiamine, riboflavin, pantothenic acid, niacin, pyridoxine, folic acid, biotin, vitamin B12 and choline.

In some embodiments, the food composition according to the present disclosure may further include a source of antioxidants.

As used herein, the expression “antioxidant” is intended to refer to a substance that is capable of reacting with free radicals and neutralizing them. Illustrative examples of such substances include, without limitation, carotenoids, including beta-carotene, lycopene and lutein, selenium, coenzyme Q10 (ubiquinone), tocotrienols, soy isoflavones, S-adenosylmethionine, glutathione, taurine, N-acetylcysteine, vitamin E, vitamin C, lipoic acid and L-carnitine.

In some embodiments, the food composition includes from about 1% to about 4% by weight of arginine, based on the total weight of dry matter of the composition.

As used herein, from about 1% by weight to about 4% by weight of arginine includes about 1.25%, about 1.50%, about 1.75%, about 2.00%, about 2.25%, about 2.50%, about 2.75%, about 3.00%, about 3.25%, about 3.50%, about 3.75% by weight of arginine, based on the total weight of dry matter of the composition.

In some embodiments, the composition further includes at least one flavor, in particular a natural flavor.

In some embodiments, the flavor is of protein origin.

In a particular embodiment, a composition of the invention does not comprise glycerol.

Preparation of the Kibbles

A food composition of the disclosure may be manufactured by a variety of processes. While the details of various manufacturing processes may differ and can be modified to reach the scope of desired end composition, an example of process used to manufacture a composition of the disclosure involves the following steps:

1) preparing a dough in a preconditioner (or conditioner, here both terms are used interchangeably) under sufficient temperature, shear, and conditions whereby the dough includes proteins, fibers, starch, and water and any optional liquid additives and/or dry additives commingled with the proteins, fibers, starch, and water in the dough;

2) extruding the dough by (i) passing it through an orifice of a die(s) of an extruder chamber, under a first set of conditions (pressure, temperature, obturation of the orifice) to form an extrudate with one empty cavity comprising at least one aperture and then (ii) expanding the extrudate under a second set of conditions (pressure and temperature) to permit the rapid expansion of water vapor (steam) from moisture held within the dough and to form pores in the extrudate;

3) portioning the expanded extrudate by cutting it into pieces;

4) drying (at ambient air temperature or with a heating process) and/or cooling (with a cooling process) the pieces to a desired moisture content, preferably at least at or below 15% of water relative to the total weight of the composition of each piece; and

5) coating the pieces with additional flowable components such as fat, dry palatant(s), wet palatant(s), and/or aromas.

The preparation of the dough involves at least the steps of combining the ingredients, e.g., at least proteins, fibers, starch and water, used to create a mass of dough and then sufficiently heating the combination of ingredients, while mixing in an extruder under pressure, to form a molten dough so that a portion of the starch undergoes sufficient gelatinization (cooking) during extrusion.

A preconditioner begins the cooking process of raw materials prior to entering the extruder. A dough or the ingredients for a dough can be mixed in the pre-conditioner with steam and/or water under controlled conditions to pre-cook or pre-heat the dough, to mix all ingredients into the dough, and/or to prepare the dough (as by hydration) for the desired conditions during extrusion cooking. Additional liquids can be added here including oils/fats and color. Preconditioners can utilize high steam and water flow rates to begin the gelatinization process while hydrating and mixing the material.

In some embodiments, a sufficient portion of proteins and starch, e.g., from about 15 wt % to about 25 wt % of proteins and from about 35% to about 65% are combined to bind together to form the backbone structure of the porous matrix upon drying and/or cooling of the extrudate after it exits the orifice of die of the extruder and undergoes expansion due, in part, to vaporization moisture in the dough and drop in pressure.

Further, the processing conditions may impact the formation of the surface pores and of the cavity in the extrudate, said processing conditions may include extruder speed, extruder temperature in one or multiple heating zones, the amount of processing water blended with the batched ingredients, the amount of batched ingredients fed into the extruder, the amount of specific mechanical energy (SME) produced by the extruder per unit of product, and the temperature of the extrudate exiting the extruder (e.g., product exit temperature). The ingredients that make up the formulation can also impact the formation of the surface pores, said ingredients may include the choice of starch such as rice, corn, wheat, etc., the choice of proteins such vegetal or animal, hydrolyzed or non-hydrolyzed, the choice of fats such as poultry fat, tallow, white grease, etc., and the addition of water. The level of each ingredient may also be important in achieving the formation of the surface pores of the porous matrix.

To start the process, ingredient(s), e.g., proteins, fibers, starch and other optional dry additives and/or wet additives, such as, for example, preservatives (BHA), are combined with water and thoroughly mixed in a preconditioner to form a dough.

In an embodiment, the ingredients are, separately or combined as a composition, ground at least once by a mill (e.g., hammer mill or other milling equipment) to a desired size prior to combining with water. This operation may be made in grinder. Preferably, the ingredients are reduced to particles the size of them may be below 1.5 mm.

The ground ingredients are, separately or combined as a composition, fed at a predetermined feed rate into the conditioner (or pre-conditioner) by a dry material hopper or line. The water can be fed at a predetermined flow rate into the conditioner by a water or steam line. The feed rate and flow rate can be calibrated to reach a desired moisture of the dough under extrusion conditions and expanded porous matrix after extrusion.

The amount of water added to the ingredients is determined by the desired moisture content of the dough to be extruded and expanded. The water can be tap, filtered or other type of potable water. The target moisture level of the molten dough during extrusion can be up to about 30 wt % of the dough.

The amount of water added into the conditioner may vary, for example, from about 1% to about 6% of total dough flow rate, preferably from about 1.5% to about 5.5%, and preferably from about 2% to about 5%.

The amount of steam water added into the extruder may vary, for example, from about 1% to about 5% and preferably from about 1.5% to about 5%, and preferably from about 2% to about 4%.

The mixing rate in the conditioner may range for example from about 70 to about 90%, preferably may be about 80%.

The apparatus(es) used to mix and heat the mixture of proteins, fibers, starch, water and other optional ingredients are not critical, and substantially any equipment capable of achieving such operations can be used. Equipment designed for performing mixing and heating operations on highly viscous materials can be used. By way of example, the dough can be prepared by mixing its components and heating the resulting mixture under pressure in any of a wide variety of conditioners that are available (e.g., Wenger).

After the dough is prepared it is transferred into the chamber of an extruder. According to one embodiment, the conditioner and the extruder may be the same apparatus, and the preparation of the dough is made in the extruder chamber.

The dough from the preconditioning process discharges from the preconditioner and enters the extruder. Here, the dough is pushed through the extruder towards a die to form an extrudate and is further shaped by the die into kibbles. Dyes, oils, water, and steam can be added into the extruder during this stage. The extruder, such as but not limited to a single-screw extruder or a twin-screw extruder, applies high temperature, pressure, and shear to induce gelatinization of starch molecules.

An extruder that permits control of the materials passing therethrough is suitable for forming the extrudate. For example, a suitable extruder can be a twin-screw with high or low flight configuration to produce a sufficient amount of high to low shear (e.g., friction) during extrusion. A single screw extruder may also be used, or any device or combination of devices useful for mixing, heating, and forming the mixture into a molten dough, and then extruding the dough through a die or other orifice. Of course, other forms of extruder and screw configurations can be used, such as, for example, a ribbon blender.

During the passage of the dough within the extruder, additional water and steam can be added to obtain a suitable consistence allowing the dough to be pushed through the orifice of the die.

The amount of water added into the conditioner may vary, for example, from about 1% to about 6% of total dough flow rate, preferably from about 1.5% to about 5.5%, and preferably from about 2% to about 5%.

The amount of steam water added into the extruder may vary, for example, from about 1% to about 5% and preferably from about 1.5% to about 5%, and preferably from about 2% to about 4%.

During extrusion, the mixture is mechanically sheared with an extruder under conditions of shear, pressure, and temperature to gelatinize the starch to the preferred amount by weight percentage. The extruder can be set at a temperature in the range from about 50° C. to about 140° C. or other suitable temperature to gelatinize starch. The processing temperature of the dough within the extruder can be higher due to the shear placed on the dough. The amount of specific mechanical work (SME) applied to the molten dough by the extruder must be sufficient to create a molten dough that can form a porous matrix with desired properties.

The temperature of the molten dough that is under pressure in the extruder can exceed the boiling point of water present in the dough that is being extruded in order that vaporization of the water within the dough can be expected when the pressure applied to the molten dough in the extruder is released as the dough exits the extruder. The dough can be extruded at a predetermined extrusion rate.

Within the extruder, the dough may be conveyed by a screw or a plurality of screws, e.g. at least 1 screw or no more than 2 screw, at a rate adapted to increase the pressure within the dough to allow the extrudate to expand. As example, a processing rate within an extruder may be suitably obtained with a screw speed ranging from about 300 to 600 rpm, preferably ranging from about 400 to 500 rpm.

From the extruder, the molten dough is forced through an orifice in a die plate, nozzle, or tubing to form a shaped extrudate at ambient air pressure. In one embodiment, the orifice is in a die plate. In another embodiment, the die plate may include at least one orifice, and preferably up to 5 or 6 orifices. The number of orifices is adjusted to maintain a sufficient pressure within the extruder chamber, and within the dough.

The orifice can be set depending upon the desired size and shape of the extrudate. For example, the opening can be any shape such as rectangular, circular, square, triangular, elliptical, or other symmetric or asymmetric shape.

In an embodiment, a kibble of the disclosure having a substantially cylindrical shape is intended to mean a kibble obtained through longitudinal extrusion. A longitudinal extrusion is characterized by an expansion of the product in the extend of the extruder orifice.

After extrusion, the expanded extrudate can be portioned immediately after exiting the orifice of the extruder by a cutting device (e.g., knife, guillotine, rotary knives or the like) into 3-dimensional pieces of extrudate (e.g., pellets, kibbles, etc.) having a length, width, and height. For example, the length of a piece or element of a composition of the disclosure will be adjusted by adapting the rate of extrusion and the rate of cutting.

After the extrudate is portioned into pieces, each piece may undergo a drying process that dehydrates the pieces to a desired moisture content. The drying process can involve exposing the pieces to heat in a heating device (e.g., oven, drum dryer, food dryer). The heat may include infrared radiation, microwave radiation, radio frequency radiation, direct hot air, direct flame, steam, an electric heat source, or other type of heat source. In a non-limiting embodiment, heat can be applied from about 80° C. to about 100° C. and for from about 1 minute to about 5 minutes.

Heating the pieces causes it to dry and harden and to even further expand, depending upon the amount, if any, of moisture trapped within the skeletal structure of the porous matrix

The dried pieces of extrudate can be stored indefinitely in proper storage conditions or can be immediately moved to a process for vacuum infusion of flowable ingredients into the porous matrix and/or coating with flowable ingredients. Alternatively, the pieces can be dried by way of exposure to ambient air.

In the absence of heated drying, the pieces of extrudate can be exposed to a cooling process after reaching the desired volume density and moisture content. The cooling process is used to lower the post-extrusion temperature of the pieces of the extrudate to a desired temperature by passing the pieces of the extrudate through a cooling chamber. The cooled pieces of extrudate can also be stored indefinitely under proper storage conditions or can be transported to the vacuum infusion process to infuse and/or coat them with flowable ingredients.

In an even further embodiment, the pieces of extrudate can undergo a drying process (either heated or ambient air) and then a cooling process so that the pieces of extrudate can reach the desired volume density and temperature for the vacuum infusion and/or coating process or storage.

Methods of Using the Compositions

In some aspects, a dry food composition (or kibbles) of the disclosure improves and/or maintains the health of the mouth in an individual, e.g., a companion animal, consuming said dry food composition.

In some embodiments, the individual may be a non-human mammal, and is in particular a companion animal or pet, such as a cat or a dog.

Accordingly, the present disclosure relates to a low-density dry food composition as described above for its use in the improvement and/or the maintenance of mouth health, in particular in a pet. The present disclosure relates to low-density dry food composition as described above for a non-therapeutic use in the improvement and/or the maintenance of mouth health, in particular in a pet.

The present disclosure also relates to a low-density dry food composition as described above suitable for the improvement and/or maintenance of mouth health, in particular in a pet.

More particularly, a dry food composition (or kibbles) of the disclosure is intended to improve and/or maintain the health of the teeth of an individual as defined above consuming said dry food composition.

Accordingly, another object of the disclosure is a low-density dry food composition for its use in the improvement and/or the maintenance of dental health, in particular in a pet.

A low-density dry food composition according to the disclosure in particular possess a superior ability to prevent and/or treat disorder of the mouth and in particular of dental disorders or disorders arising from said dental disorders.

Disorders that can be prevented and/or treated through the consumption of a dry food composition according to the disclosure can for example be selected from dental plaque, gingivitis, tartar and halitosis.

Accordingly, the present disclosure further relates to the low-density dry food composition for its use in the prevention and/or treatment of a disorder selected from dental plaque, gingivitis, tartar and halitosis.

A dry food composition of the disclosure may be used as complete food or a complement and is in particular a complement.

The present disclosure also relates to a method for the improvement and/or maintenance of mouth health in an individual, in particular a non-human mammal, more particularly a pet, such as a cat or a dog, including the consumption by the said individual of a composition of the disclosure.

More particularly, the present disclosure also relates to a method for the improvement and/or maintenance of dental health in an individual, in particular a non-human mammal, more particularly a pet, such as a cat or a dog, including the consumption by the said individual of a composition of the disclosure.

The present disclosure further relates to a method for preventing and/or treating, in an individual in need thereof, a disorder selected from dental plaque, gingivitis, tartar and halitosis. Said individual is in particular a non-human mammal and more particularly a pet, such as a cat or a dog.

The present disclosure moreover relates to the use of a low-density dry food composition of the disclosure for the improvement and/or maintenance of mouth health in an individual, in particular a non-human mammal and more particularly a pet, such as a cat or a dog.

The present disclosure further relates to the use of a low-density dry food composition of the disclosure for the improvement and/or maintenance of dental health in an individual, in particular a non-human mammal and more particularly a pet, such as a cat or a dog.

The present disclosure also relates to the use of a low-density dry food composition of the disclosure for the prevention and/or treatment of a disorder selected from dental plaque, gingivitis, tartar and halitosis in an individual in need thereof, in particular a non-human mammal and more particularly a pet, such as a cat or a dog.

According to an aspect of the disclosure, it relates to a composition suitable for reducing or eliminating oral health compromising (OHC) microorganisms.

The present disclosure further relates to a method for the prevention and/or treatment of a disorder selected from dental plaque, gingivitis, tartar and halitosis in an animal in need thereof, said method comprising at least a step of feeding said animal in need thereof with a low-density dry food composition according to the disclosure.

The present disclosure also relates to a method for the improvement and/or maintenance of dental health in an animal, said method comprising at least a step of feeding said animal in need thereof with a low-density dry food composition according to the disclosure.

The present disclosure is further illustrated by, without in any way being limited to, the examples below with references to the following Figures:

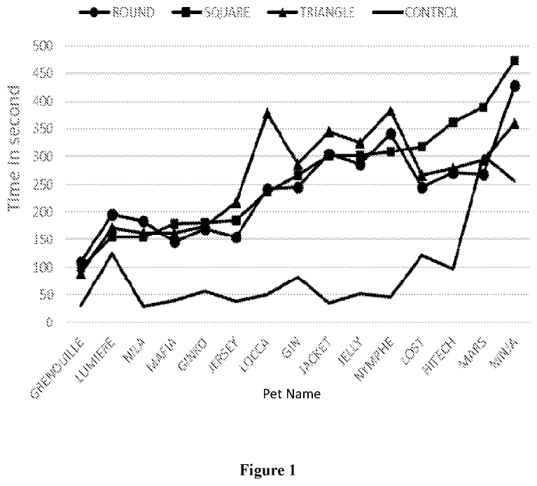

FIG. 1: A graphical depiction of the time of ingestion of various embodiments of the compositions of the disclosure.

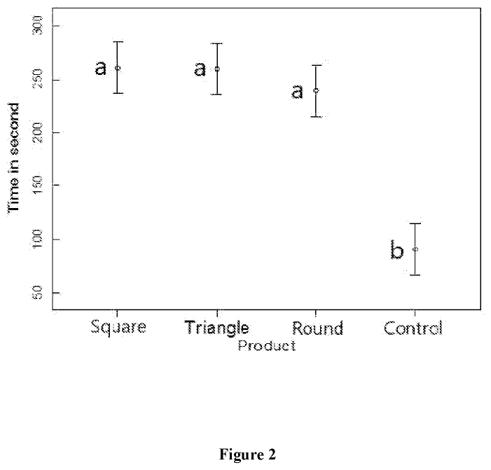

FIG. 2: Mean Product: Time in seconds+95% multiple comparison intervals (letter show Tukey group).

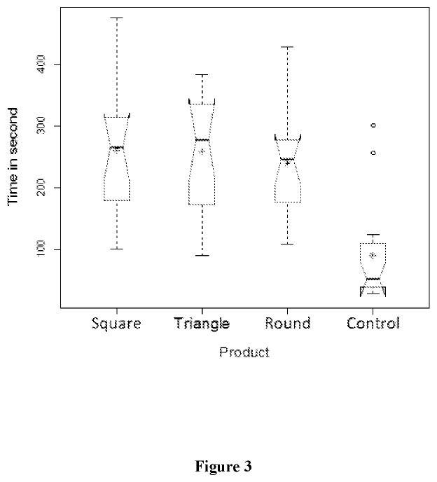

FIG. 3: Boxplot of time in second by composition.

### EXAMPLES

### Example 1

### Impact of the Fat Content of the Food Compositions on the Volume Density and Penetration Rate of Kibbles of the Disclosure

Three different formulations of food compositions according to the disclosure were prepared as kibbles (Compositions 1, 2 and 3).

These compositions were prepared with the same general process as defined above.

The dry ingredients were thus ground into a grinder to get particles below 1.5 mm. The ground ingredients were introduced in a conditioner and mixed with added water and steam to form a dough.

The dough was then transferred into an extruder and then heated under pressure. The heated dough was then pushed through a die machine to obtain an expanded extrudate which was then cut into kibbles.

The process according to the disclosure can be realized using any extruder available to the person skilled in the art. As non-limitative examples, it can be used an Extruder WENGERX115, X165 or X180 X185.

For this specific example, the amount of water added into the conditioner may vary from about 3% to about 5%, the amount of steam water added into the conditioner may vary from about 1% to about 3%.

For this specific example, the amount of water added into the extruder may vary from about 2.5% to about 5%. The amount of steam water added into the extruder may vary from about 1% to about 3%.

The parameters of this particular example consist of parameters used at the pilot scale. Considering the general knowledge of the Peron skilled in the Art, these parameters can be calculated and evaluated to fit to any industrial scale.

These three compositions, detailed in the following Table 1, differ in view of their fats content: 8%, 10% or 12% (by weight relative to the total weight of the corresponding composition).

TABLE 1

| | Composition 1 | Composition 2 | Composition 3 |
|---|---|---|---|
| Raw materials | (% total weight) | (% total weight) | (% total weight) |
| Proteins | 21 | 21 | 21 |
| Fats | 8 | 10 | 12 |
| CFIB | 1.6 | 2.1 | 2.1 |
| Ash | 5.4 | 5.4 | 5.4 |
| NFE | 54.5 | 52 | 50 |
| Moisture | 9.5 | 9.5 | 9.5 |

The volume density of the three sets of kibbles obtained was measured using the method described in the present text.

The results obtained are indicated in the following Table 2.

TABLE 2

| | Density |
|---|---|
| | (/L) |
| Composition 1 | 100 |
| Composition 2 | 100 |
| Composition 3 | 105 |

The results obtained are similar for these three compositions.

The penetration rate of the kibbles of each composition was then measured following the method detailed in the present text.

The results obtained for the penetration rates are indicated in the following Table 3:

TABLE 3

| | Penetration rate |
|---|---|
| | (%) |
| Composition 1 | 39 |
| Composition 2 | 40 |
| Composition 3 | 35 |

It is observed that the variation of the fats content in the kibbles in the specific range of a composition of the disclosure does not significantly affect the volume density and penetration rate of the generated kibbles.

### Example 2

### Impact of the Shape of the Food Compositions of the Disclosure on the Penetration Rate

Kibbles of the following composition 4 were prepared according to Table 4 either as conventionally round-liked shaped kibbles or as square-like (longitudinal) shaped kibbles.

TABLE 4

| | Composition 4 |
|---|---|
| Raw materials | (% total weight) |
| Proteins | 21 |
| Fats | 8 |
| CFIB | 2.1 |
| Ash | 5.4 |
| NFE | 54 |
| Moisture | 9.5 |

Usually, most kibbles are made using “radial” extrusion, i.e. an expansion of the product which is perpendicular to the outlet of the extruder.

Kibbles were also made, using the exact same composition, using “longitudinal” extrusion, i.e. an expansion of the product which is in line with the outlet of the extruder.

This difference leads to a change in the direction of the internal texture of the kibbles: the arrangement of the ingredients in the mass throughout its extrusion is guided horizontally, which as for consequence a different orientation of the air bubbles contained in it.

Such changes in the internal texture of the kibbles cause changes in the way the animal chews. Indeed, creating a kibble through longitudinal extrusion induces a chewing which is perpendicular to the fibres direction, allowing an improved brushing of the pet teeth.

The penetration rates of the two above-mentioned types of kibbles, having as sole differences the form and type of extrusion used, are measured according to the method detailed in the present text. The results obtained are indicated here-after in Table 5.

TABLE 5

| | Round kibbles | Longitudinal kibbles |
|---|---|---|
| Penetration rate (%) | 44.8 | 55.5 |

A 24% increase of the penetration rate is accordingly observed with the use of longitudinal kibbles compared to the round ones.

### Example 3

### Impact of Moisture of the Food Compositions on the Penetration Rate

Kibbles of the following compositions were prepared according to Table 6 using a square form either with an 8% by weight (relative to the total weight of the composition) or with a 10.5% by weight amount of water (moisture) relative to the total weight of the composition.

TABLE 6

| | Composition A | Composition B |
|---|---|---|
| Raw materials | (% total weight) | (% total weight) |
| Proteins | 21.3 | 20.8 |
| Fats | 12.2 | 11.9 |
| CFIB | 2.1 | 2.1 |
| Ash | 5.4 | 5.4 |
| NFE | 51 | 49.3 |
| Moisture | 8 | 10.5 |

The penetration rates of these two types of kibbles are measured according to the method detailed in the present text and indicated here-after in Table 7.

TABLE 7

| | Composition A | Composition B |
|---|---|---|
| | (Moisture 8% by | (Moisture 10.5% by |
| | weight) | weight) |
| Penetration rate (%) | 45.1 | 56 |

An increase superior to 24% of the penetration rate is accordingly observed with the increase of the moisture rate of the composition from 8% to 10.5% by weight.

### Example 4

### Immunoglobulins Activity Confirmation Within the Compositions of the Disclosure

The goal of this study was to examine the activity of gingipain antibody (immunoglobulins=IgY) within the expanded finished product within the composition of the disclosure. More particularly, the targeted bacteria are preferentially P. gingivalis and P. gulae.

Indeed, the ingredient has been proved to be efficient in other products (toothpaste, etc.) but never in a pet food. Some complexities due to the pet food process (temperature of coating process, addition of acid raw material in coating . . . ) can affect the activity of the immunoglobulins.

The kibbles according to the disclosure were coated with aroma, fat and immunized egg powder (containing IgY). 3 samples of finished products (Sample No.1, No.3 and No.5) were analyzed by Elisa to measure the activity retained of specific gingipain antibody. Non-coated kibbles, without any coating ingredients, and without immunized egg powder (Sample No.2 and No.4) have been analyzed by Elisa and were used as the negative control.

The 3 samples No.1, No.3 and No.5 of compositions according to the disclosure are close to 100%, meaning that the immunoglobulins contained in the final compositions according to the disclosure are active, so acting on dog's oral health (=reduction of dental plaque and reduction of gingivitis scoring).

TABLE 8

| Sample name | Specific gingipain antibody activity |
|---|---|
| (Kibbles according to the disclosure) | retained (%) |
| Sample No. 1 Kibbles | 97.8 |
| Sample No. 2 Kibbles | 3.8 |
| Sample No. 3 Kibbles | 82.3 |
| Sample No. 4 Kibbles | 1 |
| Sample No. 5 Kibbles | 90.9 |

### Example 5

### Dental Clinical Study

The hypothesis for this study is that the combination of chemical effects of IgY egg powder/PRN(Plaque Reduction Nutrient)/STPP and mechanical effect of the aerated texture of the composition of the disclosure will reduce the accumulation of plaque and calculus and prevent halitosis in a clean-tooth model and will reduce the growth of bacteria associated with gingivitis in dogs.

The primary objective was to demonstrate dental health improvement (a reduction of minimum 15% of at least one of the following effects: level of aroma compounds linked to bad breath, gingivitis scoring, P. gingivalis and P. gulae population, plaque scoring, tartar scoring and the most relevant: plaque accumulation detected by QLF), by feeding the dogs with 10% of their daily ration in the composition of the disclosure, compared to the control (Royal Canin Neutered Adult dry). The secondary objective is to prove the value of adding immunized egg powder in the diet to claim about “healthy gums”.

One group of 15 dogs. Each phase lasts 3 weeks to observe variations in tartar accumulation.

Each product (composition A, composition B and Control) will be given at 10% of the daily allocation in kcal. The complement will be 90% of Royal Canin Neutered Adult dry.

Composition A=PRN/STPP in coating with IgY, at 10% of the ration

Composition B=PRN/STPP in coating without IgY, at 10% of the ration

Control=Royal Canin Neutered Adult dry at 10% of the ration

### Example 6

### Ingestion Speed in Dogs

The meal duration of 3 versions of the composition according to the disclosure with different shapes (square, triangle and round) and 1 control product is evaluated in 15 small dogs from the Royal Canin kennel (internal study). The same calorie ration is offered with the 4 products: 3 versions of the composition according to the disclosure (different shapes: square, triangle, round) and 1 control product [referred as “Control” in the Figures], which is a Royal Canin dental product. The duration of each dog's meal (in seconds) is timed. Only the dogs having finished their ration (N=15) have been considered for the analysis.

Results are represented in the FIGS. 1, 2 and 3. There is no significant difference in terms of meal duration between the 3 shapes of the composition of the disclosure, but the difference between the average of the 3 versions of the disclosure and the control product is very significant, with an augmentation of 180% of the meal time, at the same calorie content. These results clearly demonstrate the capacity of the composition according to the disclosure to increase the meal duration with, consequently, an increase of the time of abrasion of the teeth of the animal eating the said composition. This example demonstrates the superior capacity to abrade or brush the teeth of an animal consuming the composition.

### Example 7

### Acceptance of the Product in Cats in the Form of a Functional Complement

The test plan was as follows:

Ranking test (a ration of 100 g is offered to cats) on 1 exposure out of 20 research cats of the following 3 products (3 different forms of the disclosure). The objective of this study was to confirm that the cat can consume 10% of its ration in composition of the disclosure. A secondary objective is to identify one of the 3 forms in terms of chewing and palatability.

TABLE 9

| | | Standard | 95% Confidence Interval | |
|---|---|---|---|---|
| Product | Mean | Error | Lower | Upper |
| Composition | 42.62 | 4.14 | 32.55 | 52.7 |
| CAT 1 | | | | |
| Composition | 41.02 | 4.14 | 30.95 | 51.1 |
| CAT 2 | | | | |
| Composition | 40.7 | 4.14 | 30.63 | 50.77 |
| CAT 3 | | | | |

The consumption of the 3 compositions according to the disclosure is almost identical and therefore does not allow a shape to be detached. Nevertheless, the 3 products are consumed on average at around 40% of the daily ration, knowing that the target for a functional complement is 10%, the product is considered palatable, the acceptance of the product is validated in cats.

1. A low-density dry food composition comprising at least:
a. a protein source in an amount ranging from about 15% to about 30% by weight relative to the total weight of the composition,
b. a fat source in an amount ranging from about 5% to about 15% by weight relative to the total weight of the composition,
c. a starch source in an amount ranging from about 35% to about 65% by weight relative to the total weight of the composition; and
d. a total dietary fibers source in an amount ranging from about 3% to about 12% by weight relative to the total weight of the composition,
wherein the composition has a penetration rate of at least about 30%.

2. The low-density dry food composition according to claim 1, having a penetration rate of from about 30% to about 75%.

3. The low-density dry food composition according to claim 1, comprising a protein source in an amount ranging from about 18% to about 25% by weight relative to the total weight of the composition.

4. The low-density dry food composition according to claim 1, wherein the protein source is selected from a vegetal protein source, an animal protein source, and mixtures thereof.

5. The low-density dry food composition according to claim 4, wherein the vegetal protein source is selected from soybean, chickpea, pea, corn gluten, lentils and barley vegetal proteins, or mixtures thereof.

6. The low-density dry food composition according to claim 4, wherein the animal protein source is selected from poultry, beef, chicken, chicken meal, lamb, lamb meal, dried egg, fish, fish meal, meat and bone meal, meat byproducts, insects, and meat meal animal proteins, and mixtures thereof.

7. The low-density dry food composition according to claim 4, wherein the protein source is selected from corn gluten vegetal proteins and poultry animal proteins.

8. The low-density dry food composition according to claim 4, wherein the ratio of animal proteins to vegetal proteins is from about 1:2 to about 2:1.

9. The low-density dry food composition according to claim 1, comprising fat in an amount ranging from about 5% to about 15% by weight, relative to the total weight of the composition.

10. The low-density dry food composition according to claim 1, wherein the said fat is selected from pork fat, pork lard, poultry fat, chicken fat, beef fat, lamb fat, fish oil and sunflower.

11. The low-density dry food composition according to claim 1, comprising starch in an amount ranging from about 35% to about 65% by weight, relative to the total weight of the composition.

12. The low-density dry food composition according to claim 1, wherein the said starch is selected from wheat, barley, tapioca, wheat flour, corn flour, rice, potatoes, peas and oat starch.

13. The low-density dry food composition according to claim 1, comprising a total dietary fibers source in an amount ranging from about 4% to about 10% by weight relative to the total weight of the composition.

14. The low-density dry food composition according to claim 1, wherein the said fibers are selected from beet pulp, soybean hulls, bran from wheat, cellulose, chicory, corn, rice bran, whole grain oat and whole grain barley fibers, and mixtures thereof.

15. The low-density dry food composition according to claim 1, further comprising ash in an amount ranging from about 2% to about 10% by weight relative to the total weight of the composition.

16. The low-density dry food composition according to claim 1, having a volume density ranging from about 100 g/L to about 250 g/L.

17. The low-density dry food composition according to claim 1, comprising an amount of water ranging from about 2% to about 11% by weight relative to the total weight of the composition.

18. The low-density dry food composition according to claim 1, comprising an effective amount of immunoglobulins.

19. The low-density dry food composition according to claim 1, having a porosity comprised between about 50% and about 85%.

20. (canceled)

21. (canceled)

22. (canceled)

23. (cancelled)

24. The low-density dry food composition according to claim 1, wherein said composition is a kibble.

25. (canceled)

26. (canceled)

27. (canceled)

28. (canceled)
